(19) United States
(12) Patent Application Publication
(10) Pub. No.: US 2006/0095175 A1
(43) Pub. Date: May 4, 2006

(54) Method, system, and apparatus for monitoring vehicle operation

(76) Inventors: Thomas deWaal, Calgary (CA); Arthur Douglas Heinrichs, Calgary (CA)

Correspondence Address: McGLEW AND TUTTLE, P.C.;Counslors at Law, SCARBOROUGH STATION, SCARBOROUGH, NY, 10210-9227, US

(21) Appl. No.: 11/264,854

(22) Filed: Nov. 2, 2005

Related U.S. Application Data
(60) Provisional application No. 60/624,193, filed on Nov. 3, 2004.

(51) Int. Cl. G06F 19/00

(52) U.S. Cl. 701/33; 701/29; 701/35; 340/438

(57) ABSTRACT

A method and an electronic system, for implementing that method, are described that collect data relating to the operation of a vehicle and the condition of its operator, which information is processed and recorded in a crash survivable apparatus such that processed information may be transmitted wirelessly from the vehicle to various monitoring facilities that may use that processed information to develop comprehensive records regarding the operation of the vehicle by the particular operator. The purpose of the records is to permit the owners of fleets to better select operators and control vehicles in a manner that permits them to develop a history of safe operation of their fleet to satisfy insurers and obtain reasonably priced insurance.

### CROSS REFERENCE TO RELATED APPLICATION

This application claims the benefit of priority under 35 U.S.C. § 120 of co-pending U.S. Provisional Patent Application U.S. 60/624,193 filed Nov. 3, 2004, the entire contents of which are incorporated herein by reference

### FIELD OF THE INVENTION

The present invention relates generally to vehicles and particularly to monitoring the status of vehicles and their operators.

### BACKGROUND OF THE INVENTION

Commercial vehicles, such as those within a trucking or rental fleet, are often operated without sufficient care and attention by drivers at locations far from the organization that is responsible for them. This creates a number of risks that result in safety concerns to the public and security concerns for the owners. In particular, injury and theft problems are of sufficient magnitude that the cost of insurance is so high that insurance is either very expensive or simply not available to many vehicle operators or owners.

In the particular instance of trucking fleets, the effect of a poorly operated truck involved in a collision can result in catastrophic losses in terms of personal injury and property damage to members of the public and to the fleet operators. In addition, the effect of a poorly operated truck can result in significant costs to the fleet operator through increased or premature maintenance costs and insurance costs. As is well known, many overworked vehicle operators fall asleep such that these often large vehicles leave the roadway with resulting damage to overhead structures such as bridges, or, more significantly causing collisions with surrounding traffic. Increased property damage and/or personal injury leads to increased insurance claims and settlements with the result that premiums become prohibitively expensive for many operators. Furthermore, poor drivers who drive aggressively and inefficiently by accelerating or braking too hard reduce vehicle life, which leads to increased maintenance costs. Still further, there remain problems with dishonest drivers or operators who falsify driving records, abuse fuel access rights, and steal cargo.

As a result, there has been a need for a comprehensive system for the reliable monitoring and timely reporting of risk factors that can be used to capture and develop operator and vehicle history, calculate risk for insurance underwriters, sanction adverse behaviour, evaluate vehicle performance and otherwise provide a full record of driving events that may be used for other purposes such as reconstructing events leading up to vehicle accidents and evaluating drivers.

A review of the prior art reveals that presently there is no system that reconciles data from different but related sources to reliably monitor the operating parameters of a vehicle and then generate a record that is useful for the above purposes. That is, the prior art in the vehicle monitoring industry has concentrated on teaching variations on stand-alone devices that work in isolation to create only local alerts that are transient in nature.

### SUMMARY OF THE INVENTION

In accordance with one aspect of the invention, there is generally provided a system that collects data relating to the operation of a vehicle and the condition of its operator, which information is processed and recorded in a crash survivable module such that processed information may be transmitted from the vehicle (preferably wirelessly and/or over the Internet or a private wide area network) to a monitoring facility that may use that processed information to develop comprehensive records regarding the operation of the vehicle.

In accordance with the invention, there is more particularly provided an electronic system, for monitoring at least one parameter of a vehicle or an operator, the system comprising: at least one sensor operatively connected to the vehicle for capturing data respecting said at least one parameter; a data processor operatively connected to the at least one sensor, for receiving, processing and interpreting data from the at least one sensor; a data storage system operatively connected to either said data processor or said at least one sensor, for receiving and storing data; and a communication system operatively connected to the data processor, for communicating data from said vehicle.

The system may further comprise any one of or a combination of an output sub-system operatively connected to the data processor for providing a visible, audible, or electrical response to the interpretation of data processor data, a biometric sub-system operatively connected to the data processor for receiving biometric information from a vehicle operator and wherein the data processor interprets the biometric information for initiating a visual, audio or electrical response, a vision sub-system operatively connected to the data processor for capturing image data relating to vehicle operation, the operating environment or the operator, a vehicle orientation and inertia module operatively connected to the data processor for receiving vehicle orientation and inertia data from the vehicle and reporting the vehicle orientation and inertia data to the data processor, an operative connection to a vehicle data network for receiving vehicle performance data from the vehicle and reporting the vehicle performance data to the data processor and/or an operator input system for providing operator input to the data processor.

In a still further embodiment, the system may further comprise an antenna operatively connected to the communication system, for receiving data from an external data source and wherein the data processor interprets the external data for reporting to the operator.

In a still further embodiment, the system may further comprise a remote processor adapted for communication with the vehicle over a local or wide area network.

In a further embodiment, the data processor may be programmed to interpret data from the at least one sensor in accordance with pre-determined thresholds such that interpreted data inconsistent with the thresholds causes a trigger event thereby causing the interpreted data to be reported to a remote processor. The remote processor may also receive and process data from any one or more of a plurality of vehicles, and interpret vehicle specific data to create a driver report relating to any trigger events for a given operator.

The system of the invention may further comprise a router operatively connected to the communication system, for transferring data across the Internet to at least one remote terminal, in order to directly monitor parameters. Alternatively, there may be included at least one server operatively connected to the router, for use as a host device to exchange data between the router and the at least one remote terminal.

According to another aspect of the invention there is provided a method, for electronically monitoring parameters, in conjunction with a trip, of a commercial vehicle having an operator, using a system having a predefined set of operational rules, the method comprising the steps: i) identify said operator and record the identity of said operator in conjunction with an electronic record file respecting said trip; ii) gather and process data respecting a plurality of vehicle parameters while in operation in order to add said vehicle parameters to said electronic record file; iii) compare at least one vehicle parameter with at least one related threshold defined in said operational rules; iv) record an event each time a vehicle parameter is inconsistent with a related threshold; v) generate an alert as defined in said operational rules; and vi) transmit said alert locally or to a remote location, for further handling.

The method of the invention may further comprise the steps: gather and process data respecting a plurality of operator parameters while said vehicle is in operation in order to add said operator parameters to said electronic record file; compare said operator parameters with a related threshold defined in said operational rules; and record an event each time an operator parameter is inconsistent with said related threshold.

The method of the invention may further comprise the step: correlate said event with other indications that the same parameter is inconsistent with said related threshold.

In yet another embodiment, the invention provides a system for electronically monitoring parameters of a commercial vehicle trip and a vehicle operator, comprising:
an identification module for identifying said operator and for recording the identity of said operator within an electronic record file respecting said trip;
a processing module for gathering and processing data respecting a plurality of vehicle parameters while in operation for adding said vehicle parameters to said electronic record file;
a comparing module for comparing at least one vehicle parameter with at least one related threshold defined within a pre-determined set of operational rules; a recording module for recording an event each time a vehicle parameter is inconsistent with a related threshold;
an alert module for generating an alert signal as defined in said operational rules; and a transmission module for transmitting said alert signal locally or to a remote location, for further handling.

### BRIEF DESCRIPTION OF THE DRAWINGS

The invention is described by the following description and drawings in which:

FIG. 1 illustrates one embodiment of the system of the present invention, showing a selection of elements associated with a vehicle being monitored;

FIG. 2 illustrates a preferred embodiment of the system of the present invention, showing remote user terminals accessing information via a host server; and,

FIG. 3 illustrates an alternate embodiment of the system of the present invention, showing remote user terminals accessing information directly over the Internet.

### DETAILED DESCRIPTION OF THE PREFERRED EMBODIMENT

With reference to the Figures, a system and method for monitoring various operating parameters of a vehicle are now described.

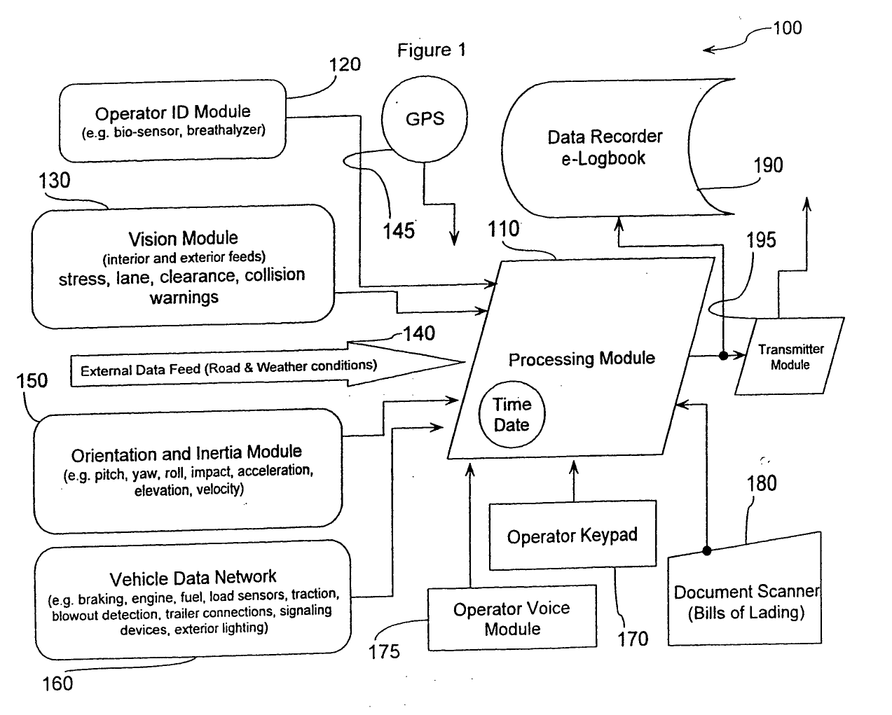

Referring to FIG. 1, there is illustrated an electronic system 100 for monitoring the operation of a vehicle (not shown) and its operator, the system 100 enabling various parameters relating to the performance and operation of both the operator and the vehicle to be gathered, analyzed, and recorded. The information obtained from such monitoring and analysis can be made available to a variety of parties including a central monitoring facility for a wide range of purposes. In its most general form, processing module 110 (e.g. a personal computer such as PC 104, a microprocessor, or an application specific integrated circuit or “ASIC”) is operatively connected to a plurality of data-gathering devices such as parameter sensors that are operatively connected to both the driver or operator and the vehicle being operated. According to a preferred embodiment of system 100, processing module 110 is also connected to transmitter module 195 in order to permit data to be wirelessly exchanged with a monitoring and control facility.

Processing module 110 may be configured to use different modes (e.g. cellular, private band, satellite) of communication at different times or in different locations, to transmit definable blocks of data that may differ according to the operating status (e.g. normal, high risk, emergency) of the vehicle. Data streams of different compositions may also be forwarded to different facilities that use different information for different purposes.

In its various embodiments system 100 includes a number of modules operatively connected to processing module 110 to enable sophisticated monitoring and data processing to be achieved. For example, Operator ID Module 120 could include different combinations of biometric identification and testing technology suitable for interfacing with a driver. Similarly, Vision Module 130 is for collecting image data relating to the specific driving events or patterns of the vehicle; Orientation and Inertia Module 150 collects vehicle motion data; Vehicle Data Network 160 collects a range of performance and status data; whereas Document Scanning module 180 processes data relating to specific shipments of goods.

System 100 may also enable use of Global Positioning System 145 input data as well as appropriate input devices such as Operator Keypad 170 and Voice module 175. According to a preferred embodiment, system 100 includes Data Recorder e-logbook 190 operatively connected to processing module 110 for recording definable vehicle data.

Examples of sensory and input devices that system 100 takes advantage of include: operator identification sensors (e.g. fingerprint or retinal readers and/or breathalyser sensors), interior and exterior cameras, air bag activation sensors, radar detection, Global Positioning System (“GPS”) devices, road & weather condition sensors (e.g. traction control technology), orientation and inertial sensors, operator keypads and microphones, image or barcode scanners, and any suitable manufacturer's Vehicle Data Network (“VDN”) (e.g. Caterpillar J1708 and J1939) used to collect operational data to service modern vehicles.

More specifically, and according to one embodiment of system 100, there is provided biometric Operator ID Module 120 capable of reliably identifying an individual within a vehicle being monitored. Module 120 will generally receive and process data relating to the identity of an individual attempting to operate a vehicle, and, after determining their identity, enable or deny access by the individual to operate the particular vehicle. It is to be understood that module 120 may incorporate sub-systems that collect and analyze data relating to the physical state of an operator (e.g. breathalyser technology, or pulse and heart-rate, et cetera). Module 120 may also include functionality that requires an operator to periodically re-enter biometric data during a trip, such that any change of operator enroute may be observed, recorded, and transmitted to any suitable monitoring and control facility for any appropriate authorization. Advantageously, module 120 also makes it possible for system 100 to disable a vehicle from starting or deactivate a running engine, if it is determined that an unauthorized individual is attempting to move the vehicle.

According to a further embodiment of system 100 a vision module 130 is included for collecting image data relating to the performance of both the operator and the vehicle. Vision module 130 may include sensors for facial recognition that permit monitoring the facial state of an operator enroute. For example, signs of distress or fatigue in an operator's face may be used to generate alerts or otherwise aid an operator while driving.

Vision module 130 may take advantage of a sub-system of cameras (e.g. Mobileye AWS, DriveCam), laser range finders, proximity sensors, and other devices that provide an operator or supervisors with warnings or records with respect to specific driving events. For example, data respecting lane changes not associated with turn signal activation, detection of hazards such as low bridges, or risk of collision with an object—can all be detected for reporting to the operator or recorded and provided to any suitable monitoring facility. For further example, and in another embodiment, when the vehicle monitored is a bus, taxi, or train carrying passengers some of who may be unruly, a driver or passengers may activate a silent alarm that triggers images from vision module 130 to be transmitted to a dispatch office or other monitoring facility where supervisors may remotely view the interior of the vehicle and assess the need for intervention to assist the operator of the vehicle.

Given the amount of data gathered by a typical vision system, in order to manage onboard storage, a short-cycle loop recording device may be used to continuously over-write its memory (e.g. every 10 minutes) in the absence of a defined event (e.g. impact, hard braking, radar detection) that causes the storage device to save the audio and video associated with the event, for future analysis. For the same reasons, according to one embodiment of system 100, vision module 130 may further comprise a video server for capturing and compressing digital images that may then be processed locally or remotely.

According to one of its embodiments system 100 includes at least one external data module 140 for accessing external data, such as road condition and weather data. The data received from module 140 may be compared to data from other vehicle sensors to enable a comparison between expected and actual weather conditions. System 100 may also enable the data collected and/or analyzed by the vehicle to be sent to a remote monitoring facility. Advantageously, each vehicle equipped with system 100 may operate as a fleet's mobile weather station, for example feeding actual road condition data back to an operational control centre in real time to permit rerouting of fleet traffic as appropriate.

A further embodiment of system 100 includes Orientation and Inertia module 150 from which processing module 110 accepts as input data information from sensors such as accelerometers and gyroscopes that enable the measurement of parameters such pitch, yaw, roll, elevation, impact, acceleration, velocity or changes in any of these as well as other statistics respecting the physical position and changes of position of the vehicle. Individual parameter data alone or in correlation with other measurements from other vehicle borne sub-systems, enables the collection of information about the behaviour of a vehicle at a point in time or over a period of time.

According to a further embodiment of system 100 there is provided a vehicle data network 160 (“VDN 160”) for collecting data relating to various vehicle operating parameters. Processing module 110 is preferably configured to query according to a native standard or protocol (e.g. J1708 or J1939), preferably through an industry standard connector (e.g. a Deutz 9-pin connector), to determine output statistics such as engine RPM, fuel pump delivery, accelerator position, as measured by the manufacturer's built-in sub-systems. Some of the data acquired in this manner may not otherwise be available, and other data may be redundant such that it is useful for error-checking both VDN 160 and system 100. A wide range of sensors such as brake wear sensors, engine performance, and fuel consumption, are standard equipment in modern vehicles as part of their onboard data network, however after-market sensors such as: tire blowout, lighting, signalling, load and traction sensors, and trailer connection sensors may supplement or enhance manufacturer's equipment and be configured to communicate with processing module 110 directly or through any suitable embodiment of VDN 160.

According to a preferred embodiment of system 100 there are provided operator input modules such as keypad 170, voice activation module 175, and document scanner 180. These operator input modules are operatively coupled to processing module 110 in order to allow an operator to control system 100 and to use system 100 to efficiently manage cargo and customer information upon pickup, during a trip, and on delivery.

According to a preferred embodiment of system 100 there is further provided data recorder 190 (e.g. a moving hard disc, an optical ROM, a solid-state chip, bubble memory, or any other suitable memory device) housed in a crash survivable housing (not shown) for creating an electronic logbook or manifest that tracks specified performance parameters and trip events, information respecting which is available to system 100. Data recorder 190 preferably meets performance specifications similar to those used in the aircraft industry (i.e. “black boxes”), but adjusted as appropriate to the vehicle industry. For example, it is contemplated that the housing withstand an impact of 3400 g's, static crush of 5000 lbs for 5 minutes, puncture resistance of a 500 lb object dropped from 10 feet on a 0.25″ point, fire at 2000 deg F. for one hour and 500 deg F. for 24 hours—all without penetrating the crash survivable housing or harming data recorder 190 inside.

Advantageously, information recorded by data recorder 190 is useful for understanding the status of both the vehicle and its operator leading up to an accident. Further, data stored by data recorder 190 is useful to owners and insurance companies to: determine service schedules, assess relative driver risk, reward good-driving behaviour, and for other purposes. Some of the data gathered by data recorder 190 is wirelessly transmitted to a remote location through transmitter module 195, permitting supervisors to monitor sensitive situations (e.g. high-risk operators or high-value cargo) in which real-time monitoring of particular elements of a fleet enroute is appropriate. Other data (e.g. engine speed, fuel consumption, load balance) may be stored continuously for future reprocessing or simply as a “service record” (e.g. for resale) of the related asset.

According to a preferred embodiment of system 100, processing module 110 and data recorder 190 are combined inside a crash survivable housing to form a protected sub-system that includes a connector (i.e. any suitable multi-pin electrical connector for exchanging data with a VDN) for exchanging data through the crash survivable housing.

By having a system 100 on each vehicle in a fleet, data may be exchanged between individual vehicles and one or more monitoring facilities using different modes and on different schedules. For example, data streams may be: continuously exchanged between a vehicle and its monitoring facility, or transmitted intermittently according to the available communication networks encountered enroute (including whenever the vehicle passes near “hotspots”), or transmitted according to pre-determined communication time schedules, or whenever a vehicle docks at the time it is parked.

According to a preferred embodiment of system 100, there are provided redundant modes of data transmission, based on the popular transmission control protocol over Internet protocol (i.e. TCP/IP), such as: a cellular network transponder, a satellite network transponder, or an RF transmitter. Cellular network transponder includes a modem adaptable to transmitting through a Cellular Digital Packet Data network using any suitable router, for transmitting data from the vehicle over the Internet. Similarly, the satellite network transponder (e.g. a Globalstar transponder) accesses a satellite network using any suitable router, for transmitting from the vehicle over the Internet. However, an RF transmitter (operating within the radio frequency portion of the electromagnetic spectrum at any suitable frequency) may also be used to reach a private WAN established to control a fleet that operates primarily within a defined region, such that routing over the Internet is not required. It is understood that laser, infra-red, or other non-RF line-of-sight means may be used.

It is contemplated that system 100 may be used, when a vehicle is stationary, by the operator to access a “fleet homepage” to make information (e.g. advertising from preferred suppliers near the vehicle's present location) available to the operator at a time when it is safe to do so. It is understood that operators may access this information according to different safety rules through any suitable display means (e.g. plasma or LCD screen, headset, “Head's Up” holographic display, speakers, et cetera) onboard the vehicle.

Similarly, when a vehicle is in motion its operator may access a critical sub-set of information (e.g. emergency road & weather condition data) that is delivered in a simple, non-distracting format to the operator. Trucking association and government highway surface condition reports are also contemplated as sources of external data that system 100 may be programmed to take advantage of at different locations or times during a trip. Further, fleet owners may discretely change the rules governing a trip in progress for a variety of reasons, including, for example, security reasons (disable truck or release cargo locks) and regulatory compliance (exceeding licensed weight).

According to one embodiment of system 100, particular onboard data streams are continuously correlated by processing module 110 for error-checking and problem avoidance purposes. For example, image data from vision module 130 may be cross-referenced with abnormal data from orientation and inertia module 150 in order to facilitate the early detection of a problem with an unstable trailer in which the load has shifted.

Similarly, monitoring fuel consumption data in correlation with fuel tank level data may be used to detect a fuel-line leak (vehicle in motion) or a fuel theft (vehicle stationary) in progress. Correlating such data continuously can be used to trigger a silent alert for further enquiry, coordinated with images from vision module 130 and/or company fuel card charges monitored from a supplier's records—to identify the most likely cause.

Many commercial vehicles are operated with separate components known as a “tractor” and a trailer. Although a data network is typically associated with the tractor, processing module 110 may also accept input from devices associated with the trailer. Hitch connection sensors, load sensors, RF and other ID chips, GPS, signal lighting, tire blowout sensors, magnetic locks, wind pressure, door ajar, temperature, and a range of other sensors may be used to gather information about a trailer for correlation with information about the tractor. For example, if a tractor becomes disconnected from the trailer that it departed with, there are a number of reasons (some legitimate and others illegal) why this might occur, such as a breakdown of the tractor necessitating switching tractors enroute, knowledge of which fact may be important to a customer awaiting a time-sensitive delivery.

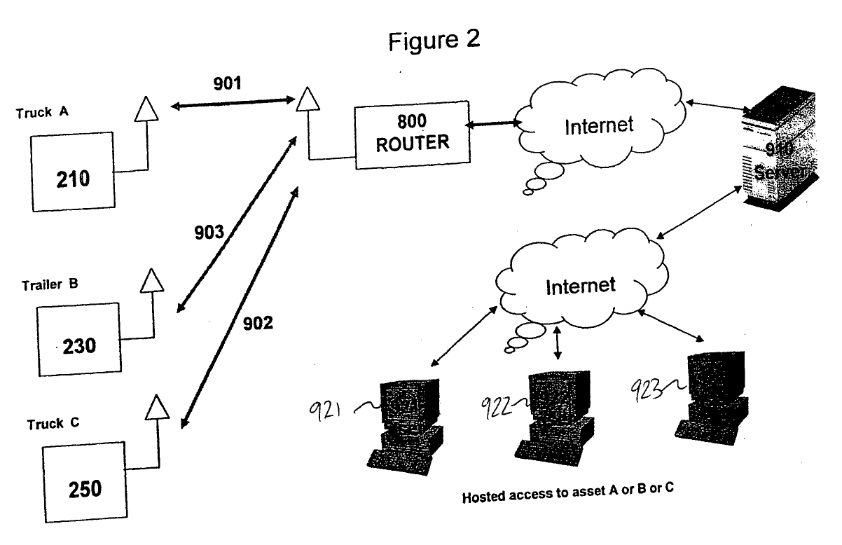

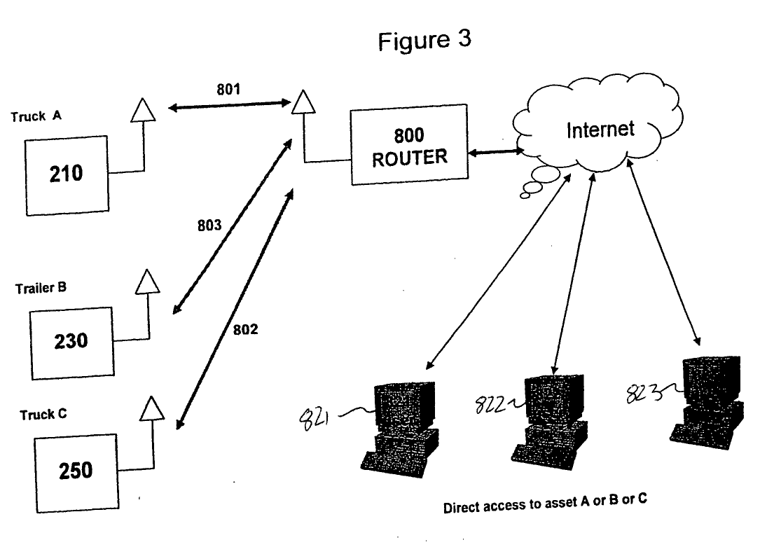

Referring now to FIG. 2 and FIG. 3, system 100 may be operated in a variety of modes, representative examples of which are set out below.

According to one embodiment of the method of the invention, a vehicle equipped with system 100 may, upon pre-determined actions by either a driver or a fleet operator, establish communication between the vehicle and a monitoring facility—preferably by wirelessly connecting to a host device (e.g. dedicated server 910 or user terminal 921), such that system 100 queries for any initial settings (including changes to its operational rules) for a specific trip. Next, processing module 110 checks for the latest upgrade of system software and downloads any upgrades, as appropriate. Next, processing module 110 responds to the host device's queries and uploads any required information (e.g. hazardous goods temperature data) typically defined in a set of rules created by the owners of the vehicle or cargo for the particular vehicle and operator combination. Some of the required information may be sensed directly (e.g. trailer weight as sensed by load cells integrated with a modern trailer) by system 100, whereas other information may need to be input by the operator (e.g. the interior trailer temperature reading taken from an older manual trailer) using keypad 170 or scanner 180. Once any required exchanges between processing module 110 and its host are complete—a trip log is initialized and the operator may commence delivery of the particular load. Depending upon many factors (e.g. new operator, dangerous cargo, poor weather) a particular trip may be monitored continuously, periodically, or only upon the occurrence of a pre-defined event that generates a system alert. Similarly, the content and density of onboard recording during a trip may be custom defined according to risk factors of interest to the specific owners or insurers.

Regardless of how system 100 is configured to monitor a trip, certain high-priority events (e.g. collision) in progress—will trigger immediate transmission of pre-specified information prior to data recorder 190 potentially being destroyed and in order to expedite an appropriate response by all of those concerned—such as emergency services, the vehicle's owners or their agents, and people waiting or responsible for the cargo.

Upon any major change of operation enroute or at the conclusion of a trip, system 100 marks or closes the related trip record file and transmits pre-specified information to one or more locations. For example, the owners of the tractor may require different information than the owners of the trailer, who may in turn require different information than the owners or insurers of the cargo. Trip information is used in many ways including: updating an operator's record (e.g. hours, reliability, speeding) with an employer, updating a vehicle's record (e.g. engine hours, load weights, burned out light bulbs) with a service department, and updating or risk indexing an owner's record (e.g. respecting mileage, risk zones entered, dangerous cargos safely hauled) with an insurance company. The resulting trustworthy and easily accessible trip records are automatically accumulated in a series of correlated and cross-referenced electronic logbooks and may be used in many decisions, including: continued employment or new hiring of operators, making critical cargo assignments only to safe operators driving highly reliable vehicles, vehicle replacement, insurability, and safe operation discounts on insurance—as a few examples.

Referring to FIG. 2, there is illustrated a preferred embodiment of the system of the invention, showing remote user terminals 921, 922, and 923 accessing information about mobile assets (e.g. trucks each having a system 100 onboard) 210, 230, and 250 through fleet control host server 910. As an example scenario, assume that truck 210 departs a fleet yard (not shown) to pickup loaded trailer 230 at a customer's yard (not shown) for transport to a remote destination (not shown) where trailer 230 will be unloaded. Truck 210 uses its system 100 (see FIG. 1) to exchange data with server 910 at the time that truck 210 leaves its yard and thereafter only as required enroute to trailer 230. Preferably, server 910 permits such exchange (and a recording) to take place continuously without human intervention and whether or not any of user terminals 921, 922, or 923 are in operation. An authorized agent of the fleet owner may then use terminal 921 at any time to alter operational rules that restrict truck 210 by uploading new rules to server 910, or by sending them over the Internet through server 910 to truck 210's system 100 on a priority interrupt basis. Similarly, if truck 210 experiences problems enroute, its system 100 may upload relevant information to server 910 on a priority basis seeking instructions from fleet operations controllers anywhere (e.g. maintenance division monitoring via terminal 923) or even confirming that truck 210 cannot complete its assigned trip. An authorized agent of the fleet may next use terminal 921 to upload instructions for replacement truck 250 located in a different yard to proceed to trailer 230 in place of truck 210. As well, an owner of trailer 230 or its cargo (e.g. a customer of fleet) may monitor permitted details of the trip in progress using terminal 922, advantageously permitting the customer (expecting the cargo to arrive at the destination) to be informed only as appropriate. Although FIG. 2 uses router 800 to interconnect with a set of networks known as the Internet, it is understood that wireless signals 901, 902, and 903 may be exchanged with server 910 more directly through a private Wide Area Network according to a different embodiment of the same invention.

Referring to FIG. 3, there is illustrated an alternate embodiment of the system of the invention, showing remote user terminals 821, 822, and 823 accessing information from mobile assets 210, 230, and 250 directly over the Internet. According to the embodiment shown in FIG. 3, no server 910 is required when one or more of terminals 821, 822, and 823 are in operation in a peer to peer mode communicating through a suitable network with any or all of: truck 210, trailer 230, or truck 250.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements. Although the disclosure describes and illustrates various embodiments of the invention, it is to be understood that the invention is not limited to these particular embodiments. Many variations and modifications will now occur to those skilled in the art of monitoring vehicles and their operators. For a full definition of the scope of the invention, reference is to be made to the appended claims.

What is claimed is:

1. An electronic system, for monitoring at least one parameter of a ground vehicle or an operator thereof, the system comprising:
at least one sensor operatively connected to the vehicle for capturing data respecting said at least one parameter;
a data processor operatively connected to the at least one sensor, for receiving, processing and interpreting data from the at least one sensor;
a data storage system operatively connected to either said data processor or said at least one sensor, for receiving and storing data; and
a communication system operatively connected to the data processor, for wirelessly communicating data from said vehicle.

2. An electronic system as in claim 1 further comprising an output system operatively connected to the data processor for providing a visible, audible, or electrical response to the interpretation of data processor data.

3. An electronic system as in claim 2 further comprising a biometric sub-system operatively connected to the data processor for receiving biometric information from a vehicle operator and wherein the data processor interprets the biometric information for initiating a visual, audio or electrical response.

4. An electronic system as in claim 2 wherein the biometric sub-system includes any one of or a combination of a fingerprint scanner, a retinal scanner, a breathalyser, and a facial recognition system.

5. An electronic system as in claim 1 further comprising a vision sub-system operatively connected to the data processor for capturing image data relating to vehicle operation, the operating environment or the operator.

6. An electronic system as in claim 1 further comprising an antenna operatively connected to the communication system, for receiving data from an external data source and wherein the data processor interprets the external data for reporting to the operator.

7. An electronic system as in claim 1 further comprising a vehicle orientation and inertia module operatively connected to the data processor for receiving vehicle orientation and inertia data from the vehicle and reporting the vehicle orientation and inertia data to the data processor.

8. An electronic system as in claim 1 further comprising a vehicle data network operatively connected to the data processor for receiving vehicle performance data from the vehicle and reporting the vehicle performance data to the data processor.

9. An electronic system as in claim 1 further comprising an operator input system for providing operator input to the data processor.

10. An electronic system as in claim 1 wherein the data processor is programmed to interpret data from the at least one sensor in accordance with pre-determined thresholds and wherein interpreted data inconsistent with the pre-determined thresholds causes a trigger event thereby causing the interpreted data to be reported to a remote processor.

11. An electronic system as in claim 1 further comprising a remote processor adapted for communication with the vehicle over a local or wide area network.

12. An electronic system as in claim 11 wherein the remote processor receives and processes data from a plurality of vehicles.

13. An electronic system as in claim 11 wherein the remote processor interprets vehicle specific data to create a driver report relating to the trigger events for a given operator.

14. An electronic system as in claim 1 wherein the at least one sensor is selected from any one of or a combination of: a GPS receiver; a scanner; a camera; an accelerometer; a gyroscope; an RF receiver; a satellite receiver; a cellular receiver; an altimeter; a proximity sensor; a load cell; a security card scanner; a keypad; a microphone; a breathalyser; a facial recognition sub-system; and a biometric sub-system.

15. An electronic system as in claim 1, further comprising a router operatively connected to the communication system, for transferring data across the Internet to at least one remote terminal, for directly monitoring said at least one parameter.

16. An electronic system as in claim 15, further comprising at least one server operatively connected to said router, for use as a host device to exchange data between said router and said at least one remote terminal.

17. An electronic system as in claim 1 further comprising local display means onboard the vehicle.

18. A method, for electronically monitoring parameters, in conjunction with a trip, of a commercial vehicle having an operator, using a system having a predefined set of operational rules, the method comprising the steps:
i) identify said operator and record the identity of said operator in conjunction with an electronic record file respecting said trip;
ii) gather and process data respecting a plurality of vehicle parameters while in operation in order to add said vehicle parameters to said electronic record file;
iii) compare at least one vehicle parameter with at least one related threshold defined in said operational rules;
iv) record an event each time a vehicle parameter is inconsistent with a related threshold;
v) generate an alert as defined in said operational rules; and
vi) transmit said alert locally or to a remote location, for further handling.

19. The method as in claim 18 further comprising the steps: gather and process data respecting a plurality of operator parameters while said vehicle is in operation in order to add said operator parameters to said electronic record file; compare said operator parameters with a related threshold defined in said operational rules; and record an event each time an operator parameter is inconsistent with said related threshold.

20. The method as in claim 18 further comprising the step: correlate said event with other indications that the same parameter is inconsistent with said related threshold.

21. An electronic system as in claim 1 wherein the data storage system is operatively contained within a crash-survivable housing.

22. An electronic system as in claim 21 wherein the data processor is operatively contained within the crash-survivable housing.

23. The use of a crash-survivable housing in a vehicle, the crash-survivable housing for operatively containing a data storage system for storing data relating to the operation of the vehicle.

24. A system for electronically monitoring parameters of a commercial vehicle trip and a vehicle operator, comprising:
an identification module for identifying said operator and for recording the identity of said operator within an electronic record file respecting said trip;
a processing module for gathering and processing data respecting a plurality of vehicle parameters while in operation for adding said vehicle parameters to said electronic record file;
a comparing module for comparing at least one vehicle parameter with at least one related threshold defined within a pre-determined set of operational rules;
a recording module for recording an event each time a vehicle parameter is inconsistent with a related threshold;
an alert module for generating an alert signal as defined in said operational rules; and
a transmission module for transmitting said alert signal locally or to a remote location, for further handling.
